(19) United States
(12) Patent Application Publication
(10) Pub. No.: US 2026/0084313 A1
(43) Pub. Date: Mar. 26, 2026

(54) WEATHER STRIP INSTALLATION APPARATUS

(71) Applicants: Hyundai Motor Company, Seoul (KR); Kia Corporation, Seoul (KR)

(72) Inventor: Dong Ha Jeong, Gyeonggi-do (KR)

(21) Appl. No.: 19/112,034

(22) PCT Filed: Dec. 6, 2023
(86) PCT No.: PCT/KR2023/020032

§ 371 Date: Mar. 14, 2025

(30) Foreign Application Priority Data
Dec. 19, 2022 (KR) 10-2022-0178373

(51) Int. Cl. B25J 9/16; B25J 11/00; B25J 19/02; B60J 10/86

(52) U.S. Cl. CPC B25J 9/1697; B25J 9/1687; B25J 11/005; B25J 19/023; B60J 10/86

(57) ABSTRACT

Presented is a weather strip installation apparatus comprising: a base provided at a robot arm; a pressing part provided at an end portion of the base so as to press a weather strip toward an installation part, thereby insert-coupling the weather strip to the installation part; and a guide part, which is provided on the base at a position spaced apart from the pressing part, is elongated or contracted toward the weather strip with respect to the base, and grips or releases the weather strip. According to the weather strip installation apparatus of the present invention, a weather strip can be automatically installed such that working efficiency can be improved and defect rate can be remarkably reduced. In addition, a robot is used, and the weight thereof is reduced through simplification of an installation device, and thus precise robot control and fitting operation control are possible.

### TECHNICAL FIELD

The present disclosure relates to a weather strip installation apparatus capable of conveniently installing a weather strip that is installed on a door of a vehicle and so on through an automated process and capable of significantly reducing a defect rate by accurately verifying an error.

### BACKGROUND ART

A weather strip is installed on a door of a vehicle and so on so as to block outside noise and to seal the door so that rainwater and so on are prevented from penetrating the interior of the vehicle when the weather is rainy.

The weather strip for the door of such a vehicle is formed in a shape corresponding to a door frame and is curved. Since the weather strip is formed of a rubber material and so on, more than two workers are required to perform fitting work of the weather strip accurately.

In addition, since the shape of the weather strip is complicated and the material is flexible, accurate work is not easy to be realized, so that the fitting work requires a lot of time and the defect rate is high.

In addition, when the installed weather strip is not fitted in an accurate position, noise or rainwater may enter the interior of the vehicle due to a defective fitting. Furthermore, when the weather strip is left unattended for a long period of time, there is a problem that the weather strip is damaged and repair of the weather strip is required.

The foregoing is intended merely to aid in the understanding of the background of the present disclosure, and is not intended to mean that the present disclosure falls within the purview of the related art that is already known to those skilled in the art.

### DISCLOSURE

### Technical Problem

Accordingly, the present disclosure has been made keeping in mind the above problems occurring in the related art, and an objective of the present disclosure is to provide a weather strip installation apparatus capable of conveniently installing a weather strip that is installed on a door of a vehicle and so on through an automated process and capable of significantly reducing a defect rate by accurately verifying an error.

### Technical Solution

In order to achieve the objective described above, according to the present disclosure, there is provided a weather strip installation apparatus including: a base mounted on a robot arm; a pressing part provided at an end portion of the base, the pressing part being configured to press a weather strip toward an installation part, thereby fitting and coupling the weather strip to the installation part; and a guide part provided on the base at a position spaced apart from the pressing part, the guide part being configured to be extended or contracted toward the weather strip with respect to the base, and the guide part being configured to grip or release the weather strip.

The weather strip installation apparatus of the present disclosure may further include: a camera sensor configured to photograph a forward view; and a controller configured to control the robot arm and the guide part through a photographic result, thereby coupling the weather strip to the installation part.

The installation part may be a door frame of a vehicle, and the weather strip may be a door weather strip of the vehicle.

The base may have a frame shape that extends toward the installation part, the pressing part may be mounted on the end portion of the base, and the pressing part may be configured to press the weather strip toward the installation part by being pressed by the robot arm.

The pressing part may be a pressing roller configured to be brought into close contact with the weather strip and to press the weather strip.

An outer side surface of the pressing roller may have a shape same as a shape of an outer side surface of the weather strip brought into contact with the pressing roller.

The robot arm may be primarily operated such that the pressing part presses one point of the weather strip toward the installation part so that one point of the weather strip is fitted into the installation part, and the robot arm may be secondarily operated such that the pressing part is moved in one direction so that the weather strip is continuously fitted into the installation part along one direction.

The robot arm may be primarily operated such that the pressing part presses one point of the weather strip toward a corner side of the installation part so that one point of the weather strip is fitted into a corner of the installation part.

The robot arm may be primarily operated such that the pressing part reciprocates and applies pressure around the corner of the installation part after one point of the weather strip is fitted into the corner of the installation part, thereby fitting a section of the weather strip including one point into the corner of the installation part and a point around the corner.

The guide part may be mounted on the base through a first cylinder, and the guide part may be configured to be moved forward or backward toward the weather strip with respect to the base by an extension or a contraction of the first cylinder.

The guide part may be connected to an upper portion of the base through a link, the link may be connected to a lower portion of the base through a first cylinder, the link may be configured to be rotated by an extension or a contraction of the first cylinder, and the guide part may be configured to be moved forward or backward toward the weather strip by the rotation of the link.

The guide part may include a second cylinder and a guide roller, the guide roller may be configured to be rotated and to grip the weather strip by an extension of the second cylinder, and the guide roller may be configured to be rotated in a reverse direction and to release the weather strip by a contraction of the second cylinder.

When the guide roller grips the weather strip, the guide roller may be fitted into a groove formed in the weather strip, thereby gripping the weather strip.

The guide part may be provided as a pair of guide parts provided on both sides of the pressing part, and the guide part at an opposite side of a direction at which the pressing part is moved may be contracted and may not interfere with the installation part when the pressing part installs the weather strip.

The pressing part may be mounted on the base through a damping part, and the weather strip installation apparatus of the present disclosure may further include a controller configured to control a damping force of the damping part.

The pressing part may be provided with a pressure sensor configured to measure a pressing force that presses the weather strip, and the controller may be configured to adjust the damping force of the damping part according to a measurement value of the pressure sensor.

The weather strip installation apparatus of the present disclosure may further include: a stopper having a first end portion connected to the base and having a second end portion connected to the pressing part, the stopper being configured to limit a stroke of the pressing part, wherein the controller may be configured to release the stopper and to release the limitation of the stroke of the pressing part when the pressing part presses the weather strip with a pressure less than a required pressure.

The controller may be configured to reduce the damping force of the damping part when the pressing part presses the weather strip with a pressure exceeding a reference pressure, and may be configured to increase the damping force of the damping part when the pressing part presses the weather strip with a pressure less than the reference pressure.

The controller may be configured to control the damping force of the damping part when the pressing part presses the weather strip with a pressure less than a limit pressure, and may be configured to control a position of the robot arm when the pressing part presses the weather strip with a pressure exceeding the limit pressure.

The controller may be configured to control the damping force of the damping part when the weather strip is installed on a rectilinear section, and may be configured to control a position of the robot arm when the weather strip is installed on a corner section.

### Advantageous Effects

According to the weather strip installation apparatus of the present disclosure, the weather strip is capable of being automatically installed, so that work efficiency may be increased and a defect rate may be significantly reduced.

In addition, by using the robot but reducing weight by simplifying the installation apparatus, the precise controlling of the robot and the controlling of the fitting work may be realized.

Particularly, even when the corner portion exists in the installation part into the weather strip is fitted, the weather strip is capable of being accurately and completely fitted into the installation part, so that consistency of quality may be easily secured even in mass production.

### DESCRIPTION OF DRAWINGS

FIG. 1 is a view illustrating a state in which a weather strip is installed on a door of a vehicle.

FIG. 2 to FIG. 4 are views illustrating an operation of a weather strip installation apparatus according to an embodiment of the present disclosure.

FIG. 5 and FIG. 6 are views illustrating a pressing roller and a guide roller of the weather strip installation apparatus according to an embodiment of the present disclosure.

FIG. 7 is a view illustrating a state in which the weather strip is incorrectly installed on the door of the vehicle.

FIG. 8 is a flowchart showing a control method of the weather strip installation apparatus according to an embodiment of the present disclosure.

FIG. 9 is a view illustrating the weather strip installation apparatus according to another embodiment of the present disclosure.

FIG. 10 and FIG. 11 are views illustrating a pressure sensor and a stopper of the weather strip installation apparatus in FIG. 9.

FIG. 12 to FIG. 14 are views illustrating an operation of the stopper of the weather strip installation apparatus in FIG. 9.

### MODE FOR INVENTION

Hereinafter, exemplary embodiments disclosed in the present specification will be described in detail with reference to the accompanying drawings. In the present specification, the same or similar components will be denoted by the same or similar reference numerals, and a repeated description thereof will be omitted.

Detailed description of known technologies will be omitted if it is determined that the detailed description of the known technologies obscures the embodiments of the present specification. In addition, the accompanying drawings are merely intended to easily describe the embodiments of the present specification, but the spirit and technical scope of the present specification is not limited by the accompanying drawings. It should be understood that the present specification is not limited to specific disclosed embodiments, but includes all modifications, equivalents and substitutes included within the spirit and technical scope of the present disclosure.

Terms including ordinals such as “first” or “second” used herein may be used to describe various components, but the components are not limited by the terms. The terms are used only for the purpose of distinguishing one constituent element from another constituent element.

As used herein, the singular forms are intended to include the plural forms as well, unless the context clearly indicates otherwise.

It is to be understood that terms such as “including”, “having”, and so on are intended to indicate the existence of the features, numbers, steps, actions, elements, components, or combinations thereof disclosed in the specification, and are not intended to preclude the possibility that one or more other features, numbers, steps, actions, elements, components, or combinations thereof may exist or may be added.

In the following description, the expressions “module” and “part” contained in terms of constituent components to be described will be selected or used together in consideration only of the convenience of writing the following specification, and the expressions “module” and “part” do not necessarily have different meanings or roles.

When a component is described as being “connected”, “coupled”, or “linked” to another component, that component may be directly connected, coupled, or linked to that other component. However, it should be understood that yet another component between each of the components may be present. In contrast, it should be understood that when a component is referred to as being “directly coupled” or “directly connected” to another component, there are no intervening components present.

In addition, “controller” may include a communication device configured to communicate with another controller or a sensor in order to control a function assigned thereto, a memory configured to store an operating system, logic commands, and input and output information, and at least one processor configured to perform determination, calculation, and decision necessary to control the assigned function.

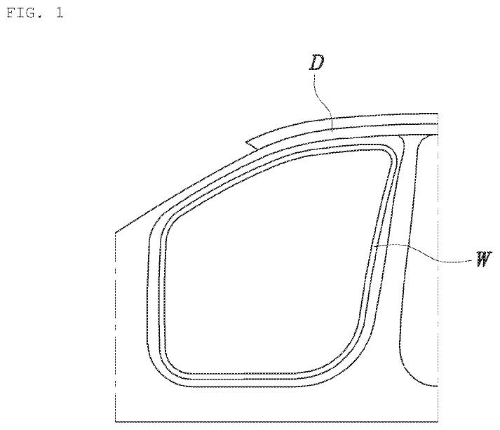

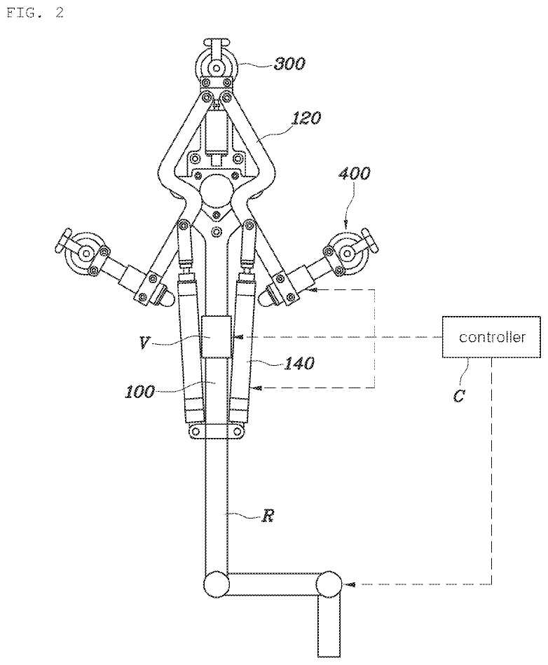

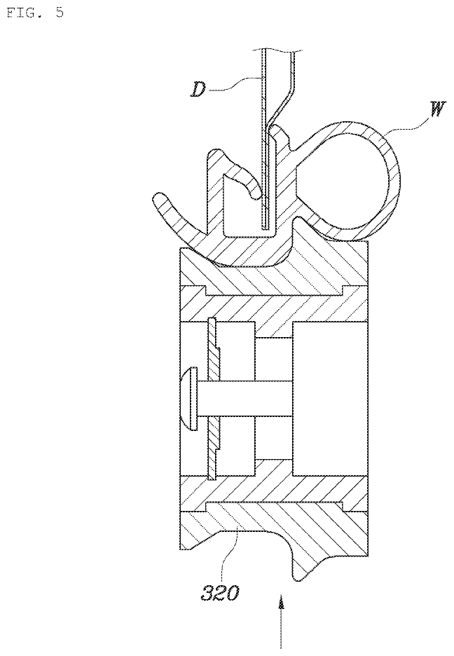

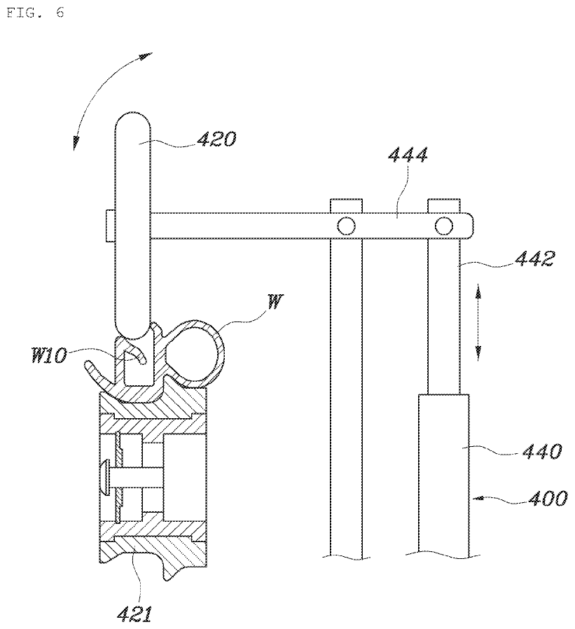

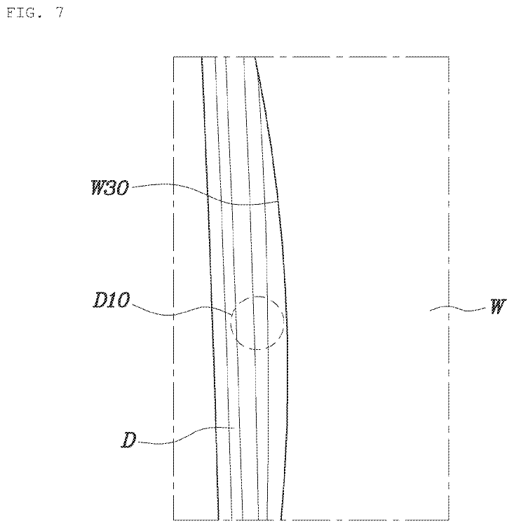

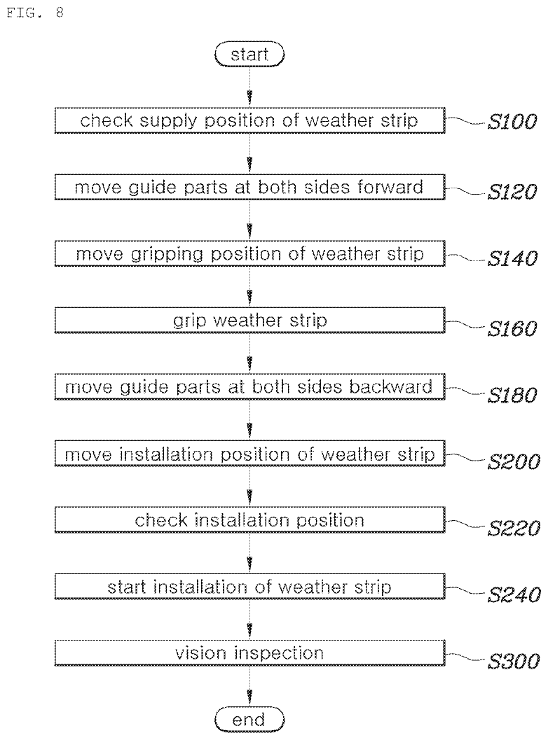

FIG. 1 is a view illustrating a state in which a weather strip is installed on a door of a vehicle, FIG. 2 to FIG. 4 are views illustrating an operation of a weather strip installation apparatus according to an embodiment of the present disclosure, FIG. 5 and FIG. 6 are views illustrating a pressing roller and a guide roller of the weather strip installation apparatus according to an embodiment of the present disclosure, FIG. 7 is a view illustrating a state in which the weather strip is incorrectly installed on the door of the vehicle, and FIG. 8 is a flowchart showing a control method of the weather strip installation apparatus according to an embodiment of the present disclosure.

First, FIG. 1 is a view illustrating a state in which the weather strip is installed on the door of the vehicle, and the weather strip may be applied to various parts, but a weather strip for a door of a vehicle is the most representative example. In addition to the door of the vehicle, the present disclosure may be applied to various parts such as a tailgate and so on of the vehicle.

As illustrated in FIG. 1, a door frame D is formed on an opening portion of the door of the vehicle, and a groove of a weather strip W is fitted and installed into the door frame D. The weather strip W is installed in a state in which the weather strip W is fitted into the door frame D, and provides a sound insulation function and a shielding function between the door and the door frame D when the door of the vehicle is closed.

Since the weather strip W has a very long length and is formed of a rubber material, the weather strip W has a lot of flexibility, so that it is very difficult for one person to hold the weather strip W and insert the weather strip W into the door frame D and the work difficulty is high. Therefore, an only skilled worker can perform the fitting of the weather strip W without error, which is very inefficient.

In addition, a corner portion is formed on the door frame D. In the corner portion, the weather strip W is difficult to be completely in close contact with and be in fitted into all sections of the corner portion, so that there is a possibility that a quality problem and so on may occur frequently after the end of installing the weather strip W.

In the present disclosure, since such a weather strip W is automatically installed through a robot, accuracy is high and efficiency is increased. Particularly, in the corner portion and so on, the weather strip W is capable of being completely fitted into the door frame D, and an error is capable of being detected through a camera sensor, so that a defect rate is significantly reduced.

Specifically, FIG. 2 to FIG. 4 are views illustrating an operation of a weather strip installation apparatus according to an embodiment of the present disclosure. Referring to FIG. 2, the weather strip installation apparatus according to the present disclosure includes: a base 100 mounted on a robot arm R; a pressing part 300 provided at an end portion of the base 100, the pressing part 300 being configured to press a weather strip W toward an installation part, thereby fitting and coupling the weather strip W to the installation part; and a guide part 400 provided on the base 100 at a position spaced apart from the pressing part 300, the guide part 400 being configured to be extended or contracted toward the weather strip W with respect to the base 100, and the guide part 400 being configured to grip or release the weather strip W.

The weather strip installation apparatus of the present disclosure may be basically operated by the robot arm R. As illustrated in the drawings, a multi-axis multi-freedom cooperation robot and so on may be applied as the robot arm R. The base 100 is mounted on an end portion of the robot arm R. In addition, the pressing part configured to press the weather strip W toward the installation part so as to fit and couple the weather strip W to the installation part is provided on a distal end portion of the base 100. Here, the installation part is an object on which the weather strip is to be assembled, and the door frame D of the vehicle may be the installation part as an example. The base 100 has a frame shape that extends toward the installation part, the pressing part 300 is mounted on the end portion of the base 100, and the pressing part 300 may press the weather strip W toward the installation part by being pressed by the robot arm R. That is, when the robot arm R presses the base 100 toward the installation part, the pressing part 300 provided on the base 100 finally presses the weather strip W toward the installation part.

In addition, the guide part 400 is provided on the base 100 at a position spaced apart from the pressing part 300, is configured to be extended or contracted toward the weather strip W with respect to the base 100, and is configured to grip or release the weather strip W, thereby guiding the weather strip W having a long length to not be sagged. Therefore, the weather strip W is prevented from being twisted and so on during installing the weather strip W, is naturally supplied, and is capable of being fitted by being pressed by the pressing part 300.

Particularly, since the guide part 400 is capable of being selectively extended and contracted, the guide part 400 is extended as required, so that the weather strip W may have a rectilinear section between the pressing part 300 and the guide part 400. Furthermore, the guide part 400 is contracted when the guide part 400 does not have to be extended, and the guide part 400 does not interfere with the door frame D and so on, so that a movement of the robot arm R is not limited. In addition, since the gripping of the weather strip W by the guide part 400 is capable of being selectively released, the weather strip W is gripped when the weather strip W is required to be gripped, so that the weather strip W is not twisted. Furthermore, when the weather strip W does not have to be gripped, the weather strip W is released so as to finish the work, whereby a finished door frame is realized and the guide part 400 is prevented from interfering with the door frame D and so on.

Meanwhile, the weather strip installation apparatus of the present disclosure further includes: a camera sensor V configured to photograph a forward view; and a controller C configured to control the robot arm R and the guide part 400 through a photographic result, thereby coupling the weather strip W to the installation part. The camera sensor V is mounted on the base 100, and is configured to photograph a direction at which the pressing part 300 faces. Furthermore, through an analysis of a photographic image from the camera sensor V, the controller C is capable of controlling a position of the robot arm R, and is also capable of analyzing an assembly defect and so on. In addition, the controller may integrally control not only the robot arm R but also the extension or contraction, the gripping or releasing, and so on of the guide part 400.

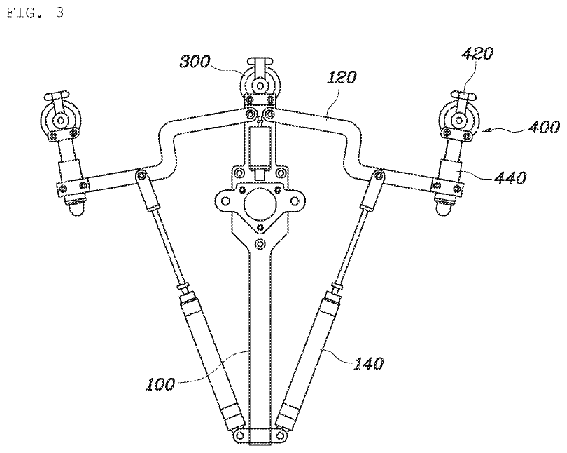

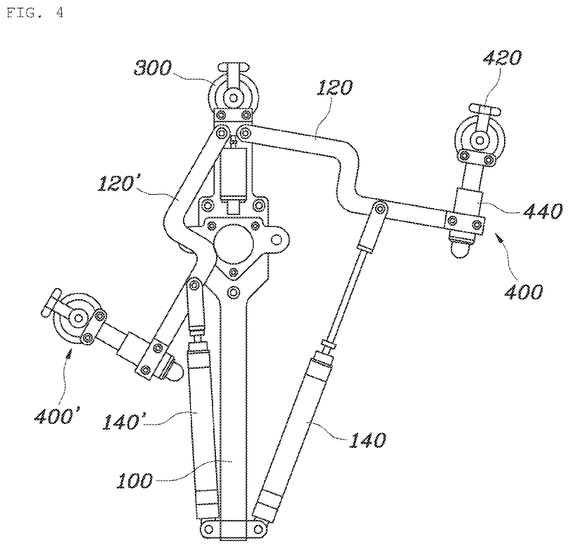

FIG. 2 is a view illustrating a normal state in which all the guide parts 400 are in a contracted state, FIG. 3 is a view illustrating a state in which the guide parts 400 at both sides are all extended, and FIG. 4 is a view illustrating a state in which only the guide part 400 at one side is extended and the guide part 400 at the other side is contracted.

Meanwhile, the pressing part 300 may be a pressing roller 320 configured to be brought into close contact with the weather strip W and to press the weather strip W, and an outer side surface of the pressing roller 320 may have a shape same as a shape of an outer side surface of the weather strip W brought into contact with the pressing roller 320. FIG. 5 is a view illustrating a shape of such a pressing roller 320. As illustrated in the cross-sectional view of the weather strip W, the outer side surface of the weather strip W may be viewed as a combination of various concave portions and various convex portions. Therefore, in order for the pressing roller 320 to evenly press the entire cross-sectional area of the weather strip W, the pressing roller 320 may be formed such that the outer side surface of the pressing roller 320 has the shape same as the shape of the outer side surface of the weather strip W brought into contact with the pressing roller 320. Through this, pressure is not concentrated on one side of the weather strip W, and the pressure is applied evenly to all sections of the weather strip W, so that a distortion of the weather strip W is prevented during the fitting process, thereby being capable of stably and uniformly fitting the weather strip W into the installation part.

Meanwhile, FIG. 6 is a view illustrating the guide part 400. The guide part 400 includes a second cylinder 440 and a guide roller 420. The guide roller 420 may be rotated and may grip the weather strip W by an extension of the second cylinder 440, and may be rotated in a reverse direction and may release the weather strip W by a contraction of the second cylinder 440. In addition, in the gripping of the weather strip W by the guide roller 420, the guide roller 420 may grip the weather strip W as the guide roller 420 is fitted into a groove W10 formed in the weather strip W.

The guide part 400 may include the second cylinder 440 and the guide roller 420 as illustrated in the drawing. When the guide roller 420 is moved close to the weather strip W, a support roller 421 provided below the guide roller 420 supports the weather strip W from below the weather strip W first. In this state, when the second cylinder 440 is operated, a piston 442 is extended, and a connection rod 444 is rotated according to the extension of the piston 442, so that the guide roller 420 is fitted into the groove W10 of the weather strip W. Through this, the weather strip W is gripped between the support roller 421 and the guide roller 420. In this state, as the pressing roller 320 is moved and the weather strip W is pressed and fitted, the weather strip W is slipped between the guide roller 420 and the support roller 421 of the guide part 400, and the weather strip W is supplied toward the pressing roller 320. As such, in order to smoothly supply the weather strip W, an upper portion and a lower portion of the guide part 400 are formed in roller shapes.

In addition, as the controller C controls the second cylinder 440, the guide part 400 may stably grip or release the weather strip W. In the releasing of the weather strip W, the cylinder is operated in a reverse direction, the piston 442 is moved downward, the connection rod 444 is rotated in a clockwise direction, and the guide roller 420 is moved upward, so that the guide roller 420 is separated from the weather strip W, thereby realizing the releasing.

Meanwhile, the guide part 400 is mounted on the base 100 through a first cylinder 140, and may be moved forward or backward toward the weather strip W with respect to the base 100 through an extension or a contraction of the first cylinder 140. In addition, the guide part 400 is connected to an upper portion of the base 100 through a link 120, the link 120 is connected to a lower portion of the base 100 through the first cylinder 140, the link 120 may be rotated by the extension or the contraction of the first cylinder 140, and the guide part 400 may be moved forward or backward toward the weather strip W by the rotation of the link 120.

In addition, the guide part 400 is provided as a pair of guide parts 400 provided on the both sides of the pressing part 300. Furthermore, when the installation of the weather strip W by the pressing part 300 is performed, the guide part 400 at a direction at which the pressing part 300 is moved may be extended and may guide the weather strip W, and the guide part 400 at the other side may be contracted and may not interfere with the installation part.

Specifically, in FIG. 2, as the first cylinder 140 is contracted, the link 120 is moved downward and is folded toward the base 100, so that the guide part 400 is positioned close to the base 100. In this state, even when the robot arm R is moved, the guide part 400 does not interfere with other parts, so that the robot arm R and the base 100 may be moved freely.

In addition, in a state in which the weather strip W is gripped by the pressing part 300 and the guide parts 400 and 400′ and the both sides, when the first cylinder 140 is contracted as illustrated in FIG. 2, a tension is generated on both sides of the weather strip W around the pressing part 300, so that the weather strip W is pulled and there is no slack. Therefore, in an initial installation of the weather strip W, when the weather strip is in the same position as in FIG. 2, an installation point of the weather strip W is more accurately designated in the initial installation, and an occurrence of an error in the initial installation may be reduced by accurately pressing the installation point.

In addition, FIG. 3 is a view illustrating a state in which the first cylinders 140 at both sides are all extended and the guide parts 400 at the both sides are all deployed accordingly. In this situation, the guide parts 400 guide the weather strip W simultaneously on the both sides of the base 100.

FIG. 4 is a view illustrating a state in which only the first cylinder 140 at one side is extended so that the link 120 at one side is deployed and only the guide part 400 at one side guides the weather strip W. In addition, since the first cylinder 140′ at the other side is not operated, the link 120′ at the other side is not deployed, so that the guide part 400′ at the other side does not interfere with other parts when the robot arm R is moved.

Generally, the door frame D of the vehicle does not have a sufficient empty space. Therefore, when the pressing roller 320 is positioned close to the corner portion of the door, it is preferable that the guide part positioned adjacent to the corner portion is contracted and folded as illustrated in FIG. 4.

Meanwhile, in order to install the weather strip W, the robot arm R is primarily operated such that the pressing part 300 presses one point of the weather strip W toward the installation part so that one point of the weather strip W is fitted into the installation part. In addition, the robot arm R is secondarily operated such that the pressing part 300 is moved in one direction so that the weather strip W is continuously fitted into the installation part along one direction.

Specifically, in a state in which the weather strip W is gripped, the robot arm R contracts the first cylinders 140 and 140′ as illustrated in FIG. 2, so that the weather strip W is accurately gripped. In this state, one point of the weather strip W is pressed toward a corner among a layout of opening portion of the door that is the installation part, so that one point of the weather strip W is fitted into the corner of the installation part. This is because the corner of the installation part is a position in which the coupling of the weather strip W is most likely to be released, so that the weather strip W is preemptively fitted into the corner of the installation part and then fitting of other parts of the weather strip W is performed.

Particularly, after the weather strip W is fitted into the corner, the pressing part 300 is configured to reciprocate around the corner, so that the weather strip W is first fitted into the corner and into a position around the corner over sections before and after one point, the sections including one point. Through this, the weather strip W is completely fitted into the corner section, and then the weather strip W is fitted into the remaining rectilinear section. As such, by fitting the weather strip W in the order of the corner section, the peripheral section, and the extension section, the possibility of the weather strip W being separated after the fitting may be significantly reduced.

That is, one point of the weather strip W is pressed first so that one point of the weather strip W is fitted into the door. In this state, the robot arm R is moved in one direction, and the weather strip W is pressed toward the door continuously while the robot arm R is moved. Then, the pressing roller 320 mounted on the robot arm R is rotated and slid along the weather strip W, and is pressing the weather strip W along a sliding path, thereby continuously fitting the weather strip W into the door. In this process, in the guide part 400 positioned in a direction at which the robot arm R is moved, the guide part 400 continuously guides the weather strip W while the guide part 400 is properly extended, so that the weather strip W is supplied well without being twisted. In addition, in some situations, the guide part 400 may guide the weather strip W while the guide part 400 is properly contracted. In addition, on the contrary, since the fitting of the weather strip W on the guide part 400′ positioned on the opposite side to the direction at which the robot arm R is moved is finished, the corresponding guide part 400′ releases the weather strip W and is in a contracted state, so that interference does not occur.

FIG. 8 is a flowchart showing a control method of the weather strip installation apparatus according to an embodiment of the present disclosure. First, the controller uses the camera sensor to check a position where the weather strip is supplied (S100). In addition, the controller moves the guide parts at the both sides forward so that the guide parts are positioned (S120 and S140). In this state, the guide parts grip the weather strip (S160). In addition, in a state in which the guide parts at the both sides are moved backward, the robot arm is moved toward the door (S180). The controller checks an installation position of the weather strip through the camera sensor, and the robot arm is moved so that the pressing roller presses the weather strip toward the door, so that an installation of the weather strip is started (S200 and S220). In addition, the robot arm is moved along the door frame, so that the entire weather strip is continuously fitted (S240).

Finally, the controller uses the camera sensor to check whether the weather strip is well installed (S300). Of course, such a check may be performed during fitting the weather strip.

FIG. 7 is a view illustrating a state in which the weather strip is incorrectly installed on the door of the vehicle. As illustrated in the drawing, an empty space D10 may be detected between a distal end portion W30 of the weather strip W and a distal end portion of the door frame D, which is detected as an error. The error may be detected by measuring a width of the empty space D10 or by measuring a slope of the distal end portion W30 of the weather strip. When the error is detected, the robot arm R is moved to a corresponding point and presses the corresponding point again with the pressing roller 320. In addition, when the error is not corrected after a re-inspection, an alarm may be provided to a worker through a warning sign and so on.

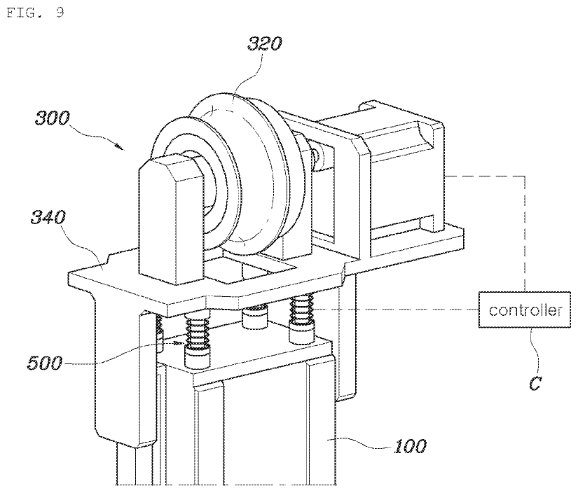

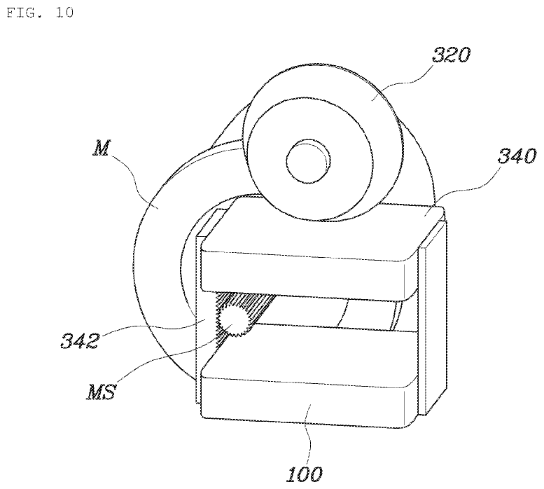

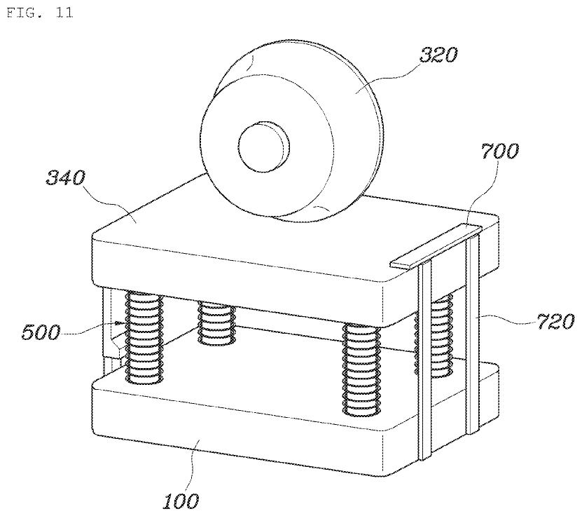

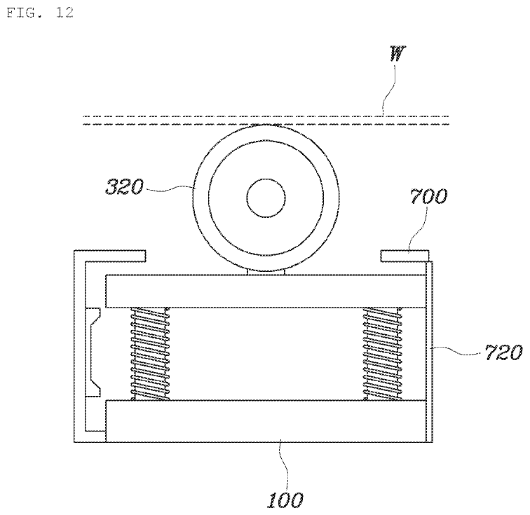

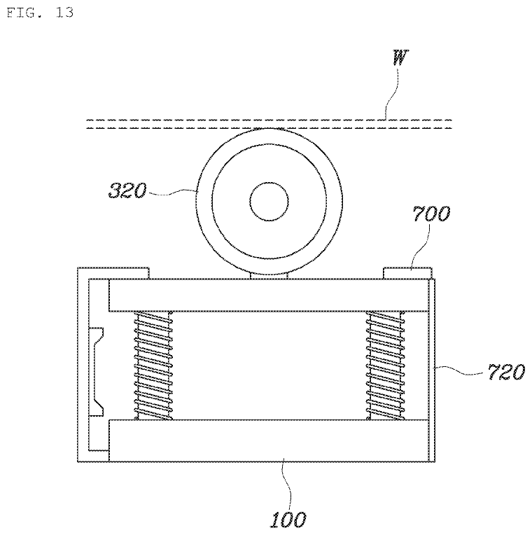

FIG. 9 is a view illustrating the weather strip installation apparatus according to another embodiment of the present disclosure, FIG. 10 and FIG. 11 are views illustrating a pressure sensor and a stopper of the weather strip installation apparatus in FIG. 9, and FIG. 12 to FIG. 14 are views illustrating an operation of the stopper of the weather strip installation apparatus in FIG. 9.

As illustrated in FIG. 9, in the weather strip installation apparatus according to another embodiment of the present disclosure, the pressing part 300 may be mounted on the base 100 through a damping part 500, and the weather strip installation apparatus of the present disclosure may further include a controller C configured to control a damping force of the damping part 500.

When the pressing part 300 is mounted on the base 100 through the damping part 500, a necessary pressing force is capable of being generated even if the control of the robot arm R is not precise. Furthermore, as the damping part 500 absorbs an excessive pressing force, the weather strip W may be prevented from being damaged. The pressing part 300 may include a cylinder and a spring as illustrated in the drawing, and the cylinder includes a pneumatic chamber and a piston, so that the cylinder may control a damping force when a pneumatic pressure is controlled. Therefore, in this situation, when the pneumatic pressure of the cylinder is reduced, the damping force of the damping part 500 is reduced. When the pneumatic pressure is increased, the damping force is increased, so that the weather strip is capable of being pressed with a greater pressing force. Of course, in the damping part 500, various controllable cylinders such as an electronic cylinder or a variable fluid-type cylinder other than the pneumatic cylinder may be applied.

In addition, the damping force of such a damping part 500 is controlled by the controller C.

Specifically, as illustrated in FIG. 10, the pressing part 300 is provided with a pressure sensor M configured to measure a pressing force that presses the weather strip W, and the controller C may adjust the damping force of the damping part 500 according to a measurement value of the pressure sensor M.

Accordingly, the controller C may reduce the damping force of the damping part 500 when the pressing part 300 presses the weather strip W to a pressure exceeding a reference pressure, and may increase the damping force of the damping part 500 when the pressing part 300 presses the weather strip W to a pressure lower than the reference pressure. A reference pressure value is stored in a memory of the controller C. A rack-pinion type sensor may be applied as the pressure sensor M, and a rotation of a pinion gear MS may be measured through an encoder of the pressure sensor M. Since a rack gear 342 performs a vertical movement along with a pressing stand 340 that supports the pressing roller 320, the movement of the rack gear 342 is capable of being measured, thereby being capable of measuring the pressing force.

The controller C may reduce the damping force of the damping part 500 when the pressing part 300 presses the weather strip W to a pressure exceeding the reference pressure, so that the controller C the weather strip W from being damaged. Furthermore, the controller C may increase the damping force of the damping part 500 when the pressing part 300 presses the weather strip W to a pressure lower than the reference pressure, so that the controller C secures an installation force of the weather strip W.

In addition, a limit pressure is input to the memory of the controller C. The controller C may control the damping force of the damping part 500 when the pressing part 300 presses the weather strip W to a pressure lower than the limit pressure. Furthermore, the controller C may control a position of the robot arm R when the pressing part 300 presses the weather strip W to a pressure exceeding the limit pressure. That is, the controller C controls only the damping part 500 when a pressure applied to the weather strip W is lower than the limit pressure, so that an appropriate pressing force is applied. Furthermore, since the required pressing force is difficult to be realized only by the controlling of the damping part 500 when a pressure applied to the weather strip W exceeds the limit pressure, the robot arm R is controlled in this situation, thereby securing the required pressing force. That is, by appropriately providing the pressing force with large or small variations according to the situation, the required pressing force is secured, and the damage to the weather strip W is prevented.

In addition, the controller C may control the damping force of the damping part 500 when the weather strip W is installed on the rectilinear section, and the controller C may control the position of the robot arm R when the weather strip W is installed on the corner section. This is because the control of the damping part 500 is required because the need for a variation in the pressing force is small when the weather strip W is installed on the rectilinear section. Furthermore, in the corner section, since an accurate measurement of the pressing force is difficult to be realized and a lot of a variation in the pressing force is required, it is preferable to control the robot arm R in this situation.

| | | | | RECTI- |
|---|---|---|---|---|
| | | | SPECIAL | LINEAR |
| | EXCEEDING | BELOW | SECTION | SECTION |
| | LIMIT | LIMIT | (CORNER | (GENERAL |
| | PRESSURE | PRESSURE | PORTION) | SECTION) |
| DAMPING | STOP | OPERATE | OPERATE | OPERATE |
| PART | | | | |
| CONTROL | | | | |
| ROBOT | OPERATE | STOP | OPERATE | STOP |
| ARM | | | | |
| CONTROL | | | | |

As shown in the table above, when the pressing force or a variation range of the pressing force exceeds the limit pressure, the control of the damping part 500 is stopped and the robot arm R is controlled. In addition, when the pressing force or the variation range of the pressing force is less than the limit pressure, the damping part 500 is controlled and the control of the robot arm R is stopped. In addition, in the corner section, the damping part 500 and the robot arm R are simultaneously controlled so as to ensure the proper installing of the weather strip. Furthermore, in the rectilinear section, only the damping part 500 is controlled.

In addition, as illustrated in FIG. 11, the weather strip installation apparatus of the present disclosure further includes a stopper 700 having a first end portion connected to the base 100 and having a second end portion connected to the pressing part 300, the stopper 700 being configured to limit a stroke of the pressing part 300. Furthermore, the controller C may release the stopper 700 and may release the limitation of the stroke of the pressing part 300 when the pressing part 300 presses the weather strip W with a pressure less than the reference pressure.

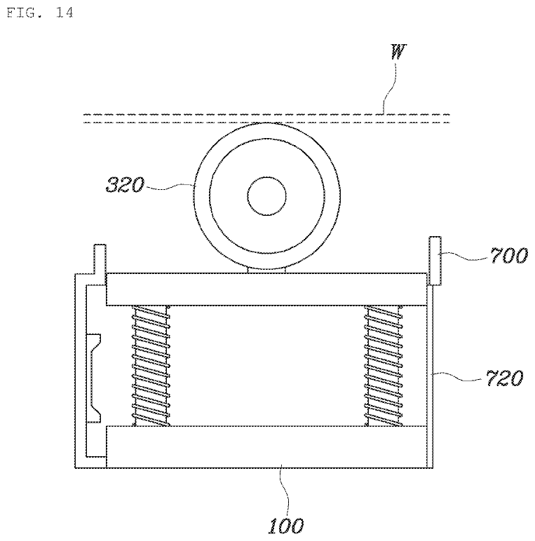

The stopper 700 is provided on a support stand 720 mounted on the base 100, and limits the stroke of the pressing part 300 toward the weather strip W. Accordingly, when the pressing part 300 presses the weather strip W with a pressure equal to or more than the required pressure as illustrated in FIG. 12 or when the pressing part 300 presses the weather strip W with the required pressure, a position of the stopper 700 is maintained at a stopping position. Furthermore, when the pressing part 300 presses the weather strip W with a pressure less than the required pressure as illustrated in FIG. 14, more pressing force is required, so that the stopper 700 is released, thereby allowing the pressing roller 320 to be moved further toward the weather strip W without limitation.

The control of the damping part and the control of the stopper are summarized as the following table.

| | EXCEEDING | | BELOW |
|---|---|---|---|
| | REFERENCE | REFERENCE | REFERENCE |
| | PRESSURE | PRESSURE | PRESSURE |
| DAMPING PART | DECREASE | MAINTAIN | INCREASE |
| STOPPER | MAINTAIN | MAINTAIN | RELEASE |

As shown in the table above, in a situation in which the required pressure and the reference pressure are set to the same value, when the pressing force is excessive than the reference pressure, the damping force of the damping part 500 is reduced and the stopper 700 maintains the stopping. In addition, when the pressing force is less than the reference pressure, the damping force of the damping part 500 is increased and the stopping of the stopper 700 is released.

According to the weather strip installation apparatus of the present disclosure, the weather strip is capable of being automatically installed, so that work efficiency may be increased and a defect rate may be significantly reduced.

In addition, by using the robot but reducing weight by simplifying the installation apparatus, the precise controlling of the robot and the controlling of the fitting work may be realized.

Particularly, even when the corner portion exists in the installation part into the weather strip is fitted, the weather strip is capable of being accurately and completely fitted into the installation part, so that consistency of quality may be easily secured even in mass production.

Although exemplary embodiments of the present disclosure have been described herein, it is understood that the present disclosure should not be limited to these exemplary embodiments and that various changes and modifications can be made by one ordinary skilled in the art within the spirit and scope of the present disclosure.

1. A weather strip installation apparatus comprising:
a base mounted on a robot arm;
a pressing part provided at an end portion of the base, the pressing part being configured to press a weather strip toward an installation part, thereby fitting and coupling the weather strip to the installation part; and
a guide part provided on the base at a position spaced apart from the pressing part, the guide part being configured to be extended or contracted toward the weather strip with respect to the base, and the guide part being configured to grip or release the weather strip.

2. The weather strip installation apparatus of claim 1, further comprising:
a camera sensor configured to photograph a forward view; and
a controller configured to control the robot arm and the guide part through a photographic result, thereby coupling the weather strip to the installation part.

3. The weather strip installation apparatus of claim 1, wherein the installation part is a door frame of a vehicle, and the weather strip is a door weather strip of the vehicle.

4. The weather strip installation apparatus of claim 1, wherein the base has a frame shape that extends toward the installation part, the pressing part is mounted on the end portion of the base, and the pressing part is configured to press the weather strip toward the installation part by being pressed by the robot arm.

5. The weather strip installation apparatus of claim 1, wherein the pressing part is a pressing roller configured to be brought into close contact with the weather strip and to press the weather strip.

6. The weather strip installation apparatus of claim 5, wherein an outer side surface of the pressing roller has a shape same as a shape of an outer side surface of the weather strip brought into contact with the pressing roller.

7. The weather strip installation apparatus of claim 1, wherein the robot arm is primarily operated such that the pressing part presses one point of the weather strip toward the installation part to allow one point of the weather strip to be fitted into the installation part, and the robot arm is secondarily operated such that the pressing part is moved in one direction so that the weather strip is continuously fitted into the installation part along one direction.

8. The weather strip installation apparatus of claim 7, wherein the robot arm is primarily operated such that the pressing part presses one point of the weather strip toward a corner side of the installation part to allow one point of the weather strip to be fitted into a corner of the installation part.

9. The weather strip installation apparatus of claim 8, wherein the robot arm is primarily operated such that the pressing part reciprocates and applies pressure around the corner of the installation part after one point of the weather strip is fitted into the corner of the installation part, thereby fitting a section of the weather strip comprising one point into the corner of the installation part and a point around the corner.

10. The weather strip installation apparatus of claim 1, wherein the guide part is mounted on the base through a first cylinder, and the guide part is configured to be moved forward or backward toward the weather strip with respect to the base by an extension or a contraction of the first cylinder.

11. The weather strip installation apparatus of claim 1, wherein the guide part is connected to an upper portion of the base through a link, the link is connected to a lower portion of the base through a first cylinder, the link is configured to be rotated by an extension or a contraction of the first cylinder, and the guide part is configured to be moved forward or backward toward the weather strip by the rotation of the link.

12. The weather strip installation apparatus of claim 1, wherein the guide part comprises a second cylinder and a guide roller, the guide roller is configured to be rotated and to grip the weather strip by an extension of the second cylinder, and the guide roller is configured to be rotated in a reverse direction and to release the weather strip by a contraction of the second cylinder.

13. The weather strip installation apparatus of claim 12, wherein, when the guide roller grips the weather strip, the guide roller is fitted into a groove formed in the weather strip, thereby gripping the weather strip.

14. The weather strip installation apparatus of claim 1, wherein the guide part is provided as a pair of guide parts provided on both sides of the pressing part, and the guide part at an opposite side of a direction at which the pressing part is moved is contracted to avoid an interference with the installation part when the pressing part installs the weather strip.

15. The weather strip installation apparatus of claim 1, wherein the pressing part is mounted on the base through a damping part, and the weather strip installation apparatus further comprises a controller configured to control a damping force of the damping part.

16. The weather strip installation apparatus of claim 15, wherein the pressing part is provided with a pressure sensor configured to measure a pressing force that presses the weather strip, and the controller is configured to adjust the damping force of the damping part according to a measurement value of the pressure sensor.

17. The weather strip installation apparatus of claim 15, further comprising:
a stopper having a first end portion connected to the base and having a second end portion connected to the pressing part, the stopper being configured to limit a stroke of the pressing part,
wherein the controller is configured to release the stopper and to release the limitation of the stroke of the pressing part when the pressing part presses the weather strip with a pressure less than a required pressure.

18. The weather strip installation apparatus of claim 15, wherein the controller is configured to reduce the damping force of the damping part when the pressing part presses the weather strip with a pressure exceeding a reference pressure, and is configured to increase the damping force of the damping part when the pressing part presses the weather strip with a pressure less than the reference pressure.

19. The weather strip installation apparatus of claim 15, wherein the controller is configured to control the damping force of the damping part when the pressing part presses the weather strip with a pressure less than a limit pressure, and is configured to control a position of the robot arm when the pressing part presses the weather strip with a pressure exceeding the limit pressure.

20. The weather strip installation apparatus of claim 15, wherein the controller is configured to control the damping force of the damping part when the weather strip is installed on a rectilinear section, and is configured to control a position of the robot arm when the weather strip is installed on a corner section.
